(19) United States
(12) Patent Application Publication
(10) Pub. No.: US 2015/0271342 A1
(43) Pub. Date: Sep. 24, 2015

(54) NETWORK RESOURCE ALLOCATION IN COMMUNICATION NETWORKS

(71) Applicant: ALCATEL LUCENT, Boulogne-Billancourt (FR)

(72) Inventors: Varun G. Gupta, Gurgaon (IN); Karan Kohli, Delhi (IN)

(73) Assignee: Alcatel Lucent, Boulogne Billancourt (FR)

(21) Appl. No.: 14/440,954

(22) PCT Filed: Oct. 8, 2013
(86) PCT No.: PCT/EP2013/070906

§ 371 Date: May 6, 2015

(30) Foreign Application Priority Data
Nov. 6, 2012 (IN) 3428/DEL/2012

(51) Int. Cl. H04M 15/00; H04M 17/00

(52) U.S. Cl. CPC H04M 15/60; H04M 15/785; H04M 17/204; H04M 15/58

(57) ABSTRACT

The present subject matter discloses systems and methods for allocating network resources in a communication network. In one implementation, the method for allocating network resources for a current call made by a subscriber comprises determining a previous actual usage parameter associated with the subscriber, wherein the previous actual usage parameter is indicative of previous allocation of the network resources made to the subscriber for at least one previous call; retrieving a previous expected usage parameter associated with the subscriber, wherein the previous expected usage parameter is indicative of expected usage of the network resources made by the subscriber for the at least one previous call; and computing a current usage parameter associated with the subscriber for a current allocation of network resources based on the previous actual usage parameter and the previous expected usage parameter. The method further comprises allocating network resources to the subscriber based on the computing.

### FIELD OF INVENTION

The present subject matter relates to communication networks and, particularly but not exclusively, to allocation of network resources in communication networks.

### BACKGROUND

Electronic devices, such as mobile phones, personal digital assistants, audio players, multimedia players, tablets, laptops, Global Positioning System (GPS) navigation systems, digital cameras, gaming consoles, pagers, and personal computers, provide users with a variety of communications services and/or computer networking capabilities. Usually, these electronic devices have capabilities to synchronize content with other electronic devices, receive content from other electronic devices, transfer content to other electronic devices, and share content with other electronic devices over communication networks provided by various network service providers. The electronic devices also facilitate the users to connect to other users using services like voice calls, short message services, multimedia message services, etc. Usually the users subscribe to one or more network service providers so as to connect to various communication networks and use the networking capabilities of the electronic devices.

Conventionally, users have to subscribe with a network service provider as a subscribers. The subscribers of the network service provider are charged by the network service provider in real or non-real time, based on the usage of network resources by the subscribers. The usage of network resources is usually measured in form of service units. The service units may be based on time or volume of data transferred. For example, voice calls are usually charged based on the duration of the voice call; whereas data calls may be charged based on the volume of data exchanged or duration of the data call. Generally, a subscriber can register and subscribe to a network service provider either as a postpaid subscriber with a postpaid subscription or as a prepaid subscriber with a prepaid subscription.

In postpaid subscription, the subscriber is billed for the usage of resources of the network service provider at periodic time intervals, such as weekly, fortnightly, and monthly. Certain network service providers, however, may bill the postpaid subscriber before the periodic time interval on the subscriber exceeding a pre-defined maximum threshold billing amount.

In prepaid subscription, the subscriber usually recharges the subscription before using the resources of the network service provider. The prepaid subscriber's balance gets deducted each and every time the subscriber uses the resources of the communication network, based on the usage of network resources by the subscriber.

Conventionally, the network service providers have an online charging system to charge the subscribers for the usage of network resources in real time. The online charging system may be configured to implement event based charging, wherein the subscribers are charged based on a billing trigger raised by a discrete event, such as sending of a short message service (SMS); and session based charging, wherein the subscribers are charged on a real time basis during the entire sessions till such a session is complete, for example, in case of a data call. Usually, the online charging system is also configured to manage the account and balance of the prepaid subscribers; i.e., credit recharges made by the prepaid subscribers to their respective account; debit the respective accounts based on usage of network resources by the prepaid subscribers; implement tariff plans availed by the prepaid subscribers, and so on.

### SUMMARY

This summary is provided to introduce concepts related to allocation of network resources in communication networks. This summary is neither intended to identify essential features of the claimed subject matter nor is it intended for use in determining or limiting the scope of the claimed subject matter.

In one embodiment, a method for allocating network resources for a current call to a subscriber of a communication network comprises determining a previous actual usage parameter associated with the subscriber, wherein the previous actual usage parameter is indicative of previous allocation of the network resources made to the subscriber for at least one previous call; retrieving a previous expected usage parameter associated with the subscriber, wherein the previous expected usage parameter is indicative of expected usage of the network resources made by the subscriber for the at least one previous call; and computing a current usage parameter associated with the subscriber for a current allocation of network resources based on the previous actual usage parameter and the previous expected usage parameter. The method further comprises allocating network resources to the subscriber based on the computing.

In another embodiment, a resource allocation system comprises a processor; and a resource request module, coupled to the processor, and configured to determine a previous actual usage parameter associated with the subscriber for a previous allocation of network resources; retrieve a previous expected usage parameter associated with the subscriber for the previous allocation of network resources; and compute a current expected usage parameter associated with the subscriber for a current allocation of network resources based on the determining and the retrieving.

Also described in one more embodiment of the present subject matter is a computer-readable medium having embodied thereon a computer program for executing a method for allocated network resources of a communication network. The method comprises determining a previous actual usage parameter associated with the subscriber, wherein the previous actual usage parameter is indicative of previous allocation of the network resources made to the subscriber for at least one previous call; retrieving a previous expected usage parameter associated with the subscriber, wherein the previous expected usage parameter is indicative of expected usage of the network resources made by the subscriber for the at least one previous call; and computing a current usage parameter associated with the subscriber for a current allocation of network resources based on the previous actual usage parameter and the previous expected usage parameter.

### BRIEF DESCRIPTION OF THE FIGURES

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The detailed description is described with reference to the accompanying figures. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a communication network environment implementation for a resource allocation system, in accordance with an embodiment of the present subject matter.

FIG. 2 illustrates the components of a resource allocation system in communication networks, in accordance with an embodiment of the present subject matter.

FIG. 3 illustrates the number of messages exchanges for grant of service units with respect to time, in accordance with an embodiment of the present subject matter.

FIG. 4 illustrates an exemplary method for allocating service units of network resources, in accordance with an embodiment of the present subject matter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DESCRIPTION OF EMBODIMENTS

Systems and methods for allocation of network resources are described. The systems and methods can be implemented in a variety of electronic devices. The electronic devices that can implement the described method(s) include, but are not limited to, personal computers, servers, network servers, mainframe systems. Further, the systems may be implemented over a distributed computing environment, a cloud computing environment, and so on.

The network service providers typically provide various voice and/or data services to subscribers of the network service providers using one or more wired and/or wireless communication networks. Examples of the services include, but are not limited to, cellular telephony services, access to the Internet, gaming, broadcasting or multicasting of audio, video, multimedia programming and applications, and so on. The subscribers may use various electronic devices, such as mobile phones, personal digital assistants, audio players, multimedia players, tablets, laptops, Global Positioning System (GPS) navigation systems, digital cameras, gaming consoles, pagers, tablets, net-books, and personal computers, to access the services provided by the network service providers. The communication between the electronic devices and the network service providers are usually in conformance with various standards and/or protocols, such as the standards and protocols defined by the 3rd Generation Partnership Project (3GPP), the International Organization for Standardization (ISO), the International Telecommunications Union (ITU), the Institute of Electrical and Electronics Engineers (IEEE), and the Internet Engineering Task Force (IETF).

The network service providers may use various conventionally known offline and online billing systems to record charges incurred by each electronic device for using the various services provided by the network service providers. Some of the standards usually define guidelines on implementation of the offline and online billing systems. For example, the 3rd Generation Partnership Project (3GPP) standards have defined a set of specifications that may be used as guidelines to implement online charging systems and offline charging systems to charge a subscriber for using the network resources.

In the online charging mechanism implemented by the online charging system, the charging information may affect, in real-time, the service(s) rendered by the network service provider, and therefore a direct interaction of the online charging system with session/service control is usually implemented. The charging information may include number of service units used; volume of data uploaded and downloaded; duration and time of usage of network resources; and charging events. In the online charging mechanism, the charging information for usage of network resource is recorded concurrently with the network resource usage. However, an authorization for the network resource usage must be obtained by the communication network prior to the actual network resource usage by the subscriber. As mentioned earlier, the network resource usage may be measured in terms of service units. The service units may be quantized based on units of time consumed or units of volume of data transferred or may be fixed for a session.

In one conventional approach of obtaining the authorization, the communication network includes a charging trigger module (CTM) to implement charging trigger functions (CTF). The CTFs refer to triggers generated by the communication network which are targeted towards the charging systems to initiate or continue or terminate the charging for a particular session of a subscriber. Authorization may be understood to be the allowance to use a service provided by the service provider, if the credit of the subscriber is sufficient or if the subscriber has subscribed to a particular service. In one implementation, the CTM may be configured to rate the network usage, i.e., compute the charges for utilizing a service which may include measuring the usage of network resources; whereas in other implementations the CTM may be configured to measure the network resource usage only.

The CTM may then transmit charging messages, containing the collated charging information, to an online charging system (OCS) to obtain authorization for the charging event or network resource usage requested by the subscriber. The OCS may be understood to be a system that facilitates a service provider to charge their subscriber, in real time, based on usage. The CTM delays the actual network resource usage until authorization has been obtained from the OCS. When a granted quota of network resource, in terms of service units, is obtained from the OCS, the CTM performs budget control during the network resource usage. The CTM enforces termination of the subscriber's network resource usage when permission by the OCS is not granted or expires.

In offline charging, the charging information does not affect, in real-time, the service rendered. In offline charging, charging information for network resource usage is collected concurrently with resource usage. The CTM triggers charging events, collects charging information pertaining to the charging events, and assembles the charging information into matching charging events. The CTM then transmits accounting messages to a charging data module (CDM) for billing the subscriber at periodic intervals or on the subscriber exceeding a pre-defined maximum threshold billing amount. The CDM may be configured to generate charging data records (CDRs) with a pre-defined content and format based on the charging events received from the CTM.

In conventional systems, the whole of the network resource to which the subscriber is entitled, is not allocated to the subscriber at one go. During a voice call or data session, the network resource is allocated to the subscriber in terms of a predefined, say X number of service units for a pre-defined time interval or duration. On consumption of the allocated number of service units, the network resource may be reallocated on a recurrent basis. In one implementation, the number of service units, i.e., X, may either be defined by the CTM or at the OCS. For example, in case of data calls, it is the CTF which triggers the OCS for requesting a designated number of service units ‘X’; and the OCS commits the charges on the account of the subscriber, and grants the requested or lesser number of service units to the CTF, based on the balance in the account of the subscriber. However, in case of a voice call, the OCS may be configured to manage the evaluation of the rate, commit the charges, and grant the requested number of service units.

On the consumption of the X number of service units by the subscriber, the CTM requests the OCS for allocation of another X number of service units to the subscriber. The OCS authorizes the CTM for allocation provided that the subscriber has credit for the same, i.e., in case of a postpaid subscriber, the subscriber has not reached the pre-defined maximum threshold billing amount, and in case of a prepaid subscriber has not used up the whole of his account balance. The OCS may also authorize the allocation of a number of the service units lesser than the predefined number, if the subscriber's credit does not permit the allocation of the X number of service units.

However, various subscribers have different traits of usage. Some subscribers may be very heavy data consumption rate subscribers, whose voice calls frequently last for a long time duration, say for thirty minutes and above; whereas other subscribers may be very light data consumption rate subscribers, whose voice calls last for a short time duration and may rarely exceed, say three minutes. In another example, some light data consumption rate subscribers on average may be consuming less volume of data in each data session, say in the order of few megabytes; whereas some other extreme heavy data consumption rate subscribers may upload or download a large volume of data in each data session, say in the order of gigabytes.

In the conventional implementation, the CTM exchanges a high number of network messages with OCS, requesting recurrent allocation of service units for the very heavy data consumption rate subscribers during the entire data session, on expiration of each pre-defined, fixed service units, i.e., where the actual number of service units consumed is much higher than the pre-defined number of service units. It may be noted that these predefined value of units to be granted during each request may be defined at either the OCS or the CTM, depending on the functional architecture of the communication network and the communication network protocol followed. This adds to the network overload and overloading of the OCS.

Similarly, for very light data consumption rate subscribers, where the actual number of service units consumed is much lesser than the pre-defined number of service units, the CTM will reserve an unnecessary number of service units for said session, which may prevent the subscriber from initiating a parallel or concurrent session. For example, suppose a light data consumption rate subscriber has a smartphone, which synchronizes with the subscriber's online accounts at the background, and the subscriber has only X number of service units in credit. Now, if the subscriber initiates a data call for synchronization, the whole X amount will be allocated for the data call, even though historically the subscriber usually uses, say 10% of X service units, per data call on average. Thus, the subscriber may be prevented from making a voice call, during the duration of data call, as the whole of the subscriber's credit has been allocated for the data call. This leads to poor utilization of the subscriber's credit resulting in dissatisfaction of the subscriber.

The present subject matter pertains to systems and methods for efficient allocation of network resources in communication networks. In one implementation, a method and system for resource allocation that provide for allocation of optimum number of service units to optimize the number of network messages for allocation of service units is described. The resource allocation systems may be implemented on various generations of communication networks following different protocols, such as Global System for Mobile Communications (GSM), Universal Mobile Telecommunications System (UMTS), Code division multiple access (CDMA), Long Term Evolution (LTE), CDMA 2000, WiMAX, Enhanced Data rates for GSM Evolution (EDGE), and Ultra Mobile Broadband (UMB). For the sake of brevity and ease of explanation, the present subject matter is described in the context of GSM networks. However, the same should not be construed as a limitation. It will be appreciated by those skilled in the art, that the present subject matter may be implemented for other communication networks, albeit modifications as would be understood by those skilled in the art.

The resource allocation system of the present subject matter includes a charging module comprising a charging trigger module (CTM) and an online charging system (OCS). In one implementation, the CTM may be implemented in a Mobile Switching Center (MSC) of a GSM network, whereas the OCS may be implemented in a Service Control Point (SCP) of a GSM network. It will be appreciated by those skilled in the art that the various functionalities of the OCS may be implemented in the CTM and vice-versa, based on the communication network architecture and the communication network protocol.

In said implementation, the OCS initially grants a pre-determined unit, say X, service units of network resource to a subscriber; wherein all the subscribers have a fixed consumption rate. The sessions having fixed consumption rate refer to the online charging sessions, such as voice calls, where the consumption of units, i.e. time, is time linear. For example, a voice call has a fixed consumption rate of service units, and the total number of service units consumed is based on time duration of the call. In said implementation, the network service provider may categorize the subscribers into multiple subscriber groups based on the average duration of a voice call made by each of the subscribers. For example, the subscribers whose average duration of voice calls is less than two minutes may be termed as very light data consumption rate subscribers; the subscribers whose average duration of voice calls is more than thirty minutes may be termed as very heavy data consumption rate subscribers, and so on. Table-1 given below provides an exemplary classification of the subscribers into five subscriber groups based on the average duration of a voice call made by each of the subscribers. However, in other implementations, the network service provider may group the subscribers into any number of subscriber groups based on actual operational data of the network service provider. Further, the network service provider may also modify the criterion for classification of the subscribers into the subscriber groups.

TABLE 1

| | Subscriber Group | | | | |
|---|---|---|---|---|---|
| | Very | | | | |
| | Light | Light | Medium | Heavy | Very Heavy |
| Average | Less than | 2-10 | 10-20 | 20-30 | Greater than 30 |
| Duration | 2 minutes | minutes | minutes | minutes | minutes |
| Usage | 1 | 2 | 3 | 4 | 5 |
| weights | | | | | |
| (W) | | | | | |
| Granted | X | 2X | 3X | 4X | 5X |
| Service | | | | | |
| Units | | | | | |
| (W × X) | | | | | |

In the Table-1 depicted above, each of the subscriber groups is associated with a usage parameter namely a usage weight. The usage weight increases with the increase in average duration of a voice call. A person skilled in the art may implement various mathematical formula and algorithms to determine the usage weights based on the average duration of a voice call. For the purpose of explanation of the present subject matter, the five subscriber groups have been assigned discrete usage weights 1, 2, 3, 4, and 5. In the present subject matter, on consumption of the predefined number of service units, i.e., the CTM may be configured to request the OCS for the usage weight number of times the predefined number of service units for allocation. The OCS may be configured to grant the CTM the requested number of service units, provided the subscriber has the requisite credit for the same. For example, if the subscriber is of the subscriber group heavy data consumption rate subscribers, the subscriber would be assigned 4X service units.

In one implementation, the OCS would by default assign a usage weight to a new subscriber for the first voice call. In one example, say the OCS assigns the new subscriber the usage weight 1. For all subsequent calls, the usage weight assigned to the new customer would be based on two usage parameters, namely, the actual usage weight for the previous session, determined based on the duration of the previous session, henceforth referred to as the previous actual usage weight; and the expected usage weight that had been estimated for the previous session, henceforth referred to as the previous expected usage weight. Thus, for calls having a fixed consumption rate of network resources, the previous actual usage parameter is the previous actual usage weight; and the previous expected usage parameter is the previous expected usage weight. The OCS may be configured to assign each of the usage parameters equal emphasis or either of the usage parameter may be assigned more emphasis than the other. For example, say the current session is N, then the previous actual usage weight, i.e., the N−1^{th} session, for a subscriber is AW_{SUB(N-1)}, and the previous expected usage weight is EW_{SUB(N-1)}. Thus, for the first session EW_{SUB(1)} may be any fixed value, say 1. Then the expected usage weight of the subscriber for the current session or call, i.e., the N^{th} session or call is determined based on equation (1) given below. The expected usage weight of the subscriber for the current session is henceforth referred to as the current expected usage weight. Thus, for calls having a fixed consumption rate of network resources, the current expected usage parameter is the current expected usage weight.

EW_{SUB(N)}=α×AW_{SUB(N-1)}+(1−α)×EW_{SUB(N-1)} Equation (1)

{0<α<1}

In the equation 1, α represents the smoothing factor. A lower value of a will give more emphasis or influence to the historic usage pattern or historic usage behavior and the expected usage weight will be less influenced by recently concluded sessions of the subscriber. A greater value of a will give less emphasis or influence to the historic usage pattern or historic usage behavior and the expected usage weight will be more influenced by recently concluded sessions of the subscriber. The value of a may be configured by the network service provider based on their actual subscriber usage data; and business policies. Based on the current expected usage weight of the subscriber, EW_{SUB(N)}, the CTM would determine the number of service units to request from the OCS for the current request or the current call.

In another example, say for a data call, the consumption rate of service units would vary from subscriber to subscriber, i.e., the subscribers would have a variable consumption rate. The sessions having a variable consumption rate refer to the online charging sessions, such as internet browsing, wherein the consumption of units, i.e., volume of data, varies according to the end-user access frequency and available bandwidth, i.e., consumption is non linear with time. The consumption rate may be dependent on various data consumption factors, like the data plan chosen by the user, communication network signal strength, mobility of the subscriber, interference, communication network traffic congestion, usage of subscriber at different time intervals, and so on. As mentioned earlier, the service units granted for data call i.e., for calls with variable consumption rate, is in terms of the volume of data to be transferred. For example, a network service provider may fix the predetermined number of service units for data calls. Each service unit may be equal to a predefined volume of data, say one hundred kilobytes (100 KB). Conventionally, on the subscriber consuming the predetermined number of service units, the CTM would request for and would be granted another predetermined number of service units for the consumption of the subscriber, provided that the subscriber has credits for the same. It would be appreciated by those skilled in the art that, since most of the data consumption factors are dynamic and may change within very short time intervals, the consumption rate of a subsequent predetermined number of service units may vary from the consumption rate of a preceding predetermined number of service units. Thus, the time interval after which the CTM would generate request for subsequent request for service units would vary.

To prevent wasting of bandwidth and overloading of the OCS, the network service provider may attempt to optimize the number of messages exchanged for the request and grant of service units. The network service provider may aim to achieve a scenario, wherein the variable consumption rate of network resources has minimal impact on the frequency of exchange of messages for the request and grant of service units. For example, the network service provider may want to have a pre-defined fixed time interval as the time duration between the requests for service units, which may be say 100 seconds. The subsequent allocations of service units may be made in accordance with the historical consumption patterns or historical usage behaviour. In order to achieve near pre-defined fixed time interval, the CTM may request for predetermined, say X, number of service units. The predetermined number may be based on the consumption rate of the subscriber. For example, if the expected consumption rate of the subscriber is 15 KB per second, and the desired gap is 100 seconds, the CTM may compute, request for and be granted 15 service units each time, i.e., 1500 kilobytes.

In said example, say the CTM assigns the new subscriber an expected volume of network resources, measured in terms of service units, as the default. For all subsequent calls, the current expected consumption rate assigned to the new customer would be based on two usage parameters, namely, the actual consumption rate for the previous granted number of service units, henceforth referred to as the previous actual consumption rate; and the expected consumption rate for the previous granted number of service units, henceforth referred to as the previous expected consumption rate. Thus, for calls having a variable consumption rate of network resources, for example, data calls, the previous actual usage parameter is the previous actual consumption rate; and the previous expected usage parameter is the previous expected consumption rate. The CTM may be configured to assign each of the usage parameters equal emphasis or either of the usage parameter may be assigned more emphasis than the other. For example, say the current request number is N, then the previous actual consumption rate for the previous request, i.e., the N−1^{th} request, for a subscriber is ACR_{SUB(N-1)}, and the previous expected consumption rate for the previous request is ECR_{SUB(N-1)}. Thus for the first request, ECR_{SUB(1)} is determined by the network service provider. Then the expected consumption rate of the subscriber for the current request, i.e., the N^{th} request is determined based on equation (2) given below. The expected consumption rate of the subscriber for the current request is henceforth referred to as the current expected consumption rate. Thus, for calls having a variable consumption rate of network resources, the current expected usage parameter is the current expected consumption rate.

ECR_{SUB(N)}=α×ACR_{SUB(N-1)}+(1−α)×ECR_{SUB(N-1)} Equation (2)

{0<α<1}

As defined in the equation 1, in equation 2, a represents the smoothing factor. A lower value of a will give more emphasis or influence to the historic usage pattern or historic usage behavior and the expected consumption rate will be less influenced by recent consumption rates of the subscriber. A greater value of a gives less emphasis or influence to the historic usage pattern or historic usage behavior and the expected consumption rate will be more influenced by recent consumption rates of the subscriber. The value of a may be configured by the network service provider based on their actual subscriber usage data; and business policies. Based on the current expected consumption rate of the subscriber, ECR_{SUB(N)}, the CTM would determine the number of service units to request from the OCS for the current request or the current call.

The resource allocation system, as described above, optimizes the number of requests generated by the CTM to the OCS for granting of service units. For heavy data consumption rate subscribers, the resource allocation system reduces the number of requests, thus preventing overloading of the OCS and preventing wastage of communication network bandwidth. For light data consumption rate subscribers, the CTM prevents unnecessary locking of service units from the subscriber's credit and thus facilitates the subscriber to initiate and use other concurrent session(s). Henceforth, the terms call and session are interchangeable used.

The above methods and system are further described in conjunction with the following figures. It should be noted that the description and figures merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof.

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the word “connected” is used throughout for clarity of the description and can include either a direct connection or an indirect connection.

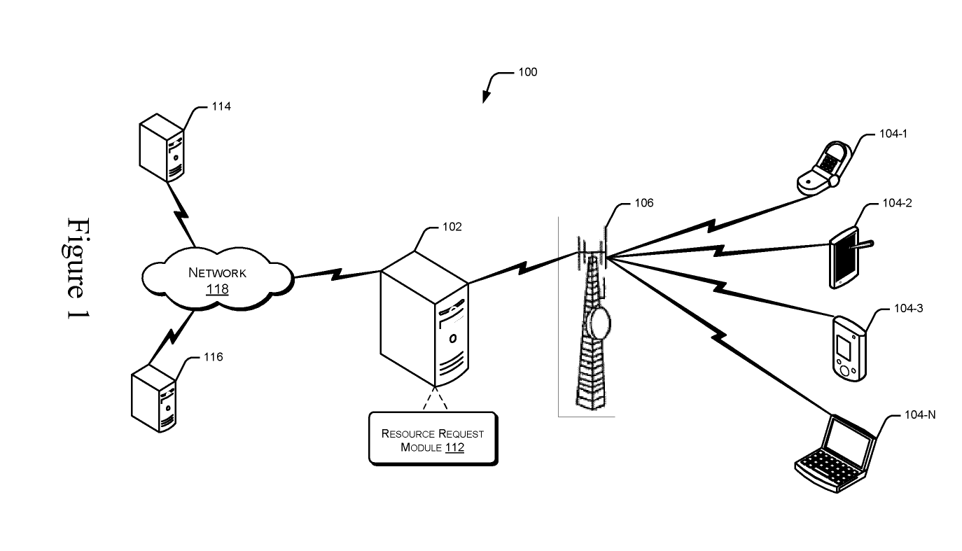

FIG. 1 illustrates a communication network environment 100 implementing a system for efficient allocation of network resources, in accordance with an embodiment of the present subject matter. In one embodiment, the communication network environment 100 includes a resource allocation system 102, a plurality of client devices, such as the client devices 104-1, and 104-2. In one implementation, the charging system may be implemented as personal computers, servers, network servers, mainframe systems. Further, the resource allocation system 102 may be implemented over a distributed computing environment, a cloud computing environment and so on. The client devices 104-1, and 104-2, collectively referred to as the client devices 104, may include various computing devices, such as a mobile phone, a smart phone, a personal digital assistant, a digital diary, a tablet, a net-book, GPS navigation systems, gaming consoles, personal computers, and the like.

The client devices 104 may communicate with the resource allocation system 102 over a communication network, such as a network 118, implemented by an access system 106. Examples of the communication network, such as the network 118, implemented by the access system 106 include Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), IP-based network, Public Switched Telephone Network (PSTN), Integrated Services Digital Network (ISDN), Long Term Evolution (LTE) networks, networks that use a variety of protocols, for example, Hypertext Transfer Protocol (HTTP), Transmission Control Protocol/Internet Protocol (TCP/IP), Wireless Application Protocol (WAP).

In one implementation, the resource allocation system 102 includes a resource request module 112 configured to optimize the number of requests for allocation of network resources. In one implementation, the functionalities of the resource request module 112 may be implemented in a Mobile Switching Center (MSC) of a GSM network, and a Service Control Point (SCP) of a GSM network.

In one implementation, the resource allocation system 102 may be communicatively coupled to a charging trigger system 114, and an online charging system 116, either directly or over the network 118. It will be appreciated by those skilled in the art that the various functionalities of the resource request module 112 may be implemented in various other network entities, such as the charging trigger system 114 for calls having variable consumption rate and the online charging system 116 for calls having fixed consumption rate, based on the network architecture and the network protocol. It will be appreciated by those skilled in the art that the various functionalities of the resource request module 112 may be implemented in various other network entities, such as the charging trigger system 114 for calls having variable consumption rate and the online charging system 116 for calls having fixed consumption rate, based on the network architecture and the network protocol.

In said implementation, the resource request module 112 may be configured to request and be granted a pre-determined unit, say X, service units of network resource to a subscriber; wherein all the subscribers have a fixed consumption rate, such as in a voice call. In said implementation, the network service provider may categorize the subscribers into multiple subscriber groups based on the average duration of a voice call made by each of the subscribers. For example, the subscribers whose average duration of voice calls is less than two minutes may be termed as very light data consumption rate subscribers; the subscribers whose average duration of voice calls is more than thirty minutes may be termed as very heavy data consumption rate subscribers and so on. The network service provider may group the subscribers into any number of subscriber groups based on actual operational data of the network service provider. Further, the network service provider may also modify the criterion for classification of the subscribers into the subscriber groups.

In said implementation, each of the subscriber groups is associated with a usage weight. The usage weight increases with the increase in average duration of a voice call. A person skilled in the art may implement various mathematical formula and algorithms to determine the usage weights based on the average duration of a voice call. For example, the network service provider may divide the average duration of a voice call by an integer, say 5, and round off the result to the next integer to obtain the usage weight.

In the present subject matter, on consumption of the predefined number of service units, i.e., the resource request module 112 may be configured to request for be granted the usage weight number of times the predefined number of service units for allocation, provided the subscriber has the requisite credit for the same.

In one implementation, the resource request module 112 may be configured to assign a default usage weight to a new subscriber for the first voice call. In one example, say the resource request module 112 is configured to assign the new subscriber the usage weight 1. For all subsequent calls, the usage weight assigned to the new subscriber would be based on two usage parameters, which are the previous actual usage weight; and the previous expected usage weight. As mentioned earlier, for a voice call, the previous actual usage parameter is the previous actual usage weight, and the previous actual expected parameter is the previous expected usage weight. The resource request module 112 may be configured to assign each of the usage parameters equal emphasis or either of the usage parameter may be assigned more emphasis than the other. As mentioned earlier, if the current session is N, then the previous actual usage weight, i.e., the N−1^{th} session, for a subscriber is represented by AW_{SUB(N-1)}, and the previous expected usage weight is represented by EW_{SUB(N-1)}. Thus, as mentioned earlier, for the first session EW_{SUB(1)} may be any fixed value, say 1. Then the current expected usage weight of the subscriber for the current session, i.e., the N^{th} session is determined based on equation (1) which is reproduced below for the sake of readability.

EW_{SUB(N)}=α×AW_{SUB(N-1)}+(1−α)×EW_{SUB(N-1)} Equation (1)

{0<α<1} . . . (1)

In the equation 1, a represents the smoothing factor. A lower value of a will give more emphasis or influence to the historic usage pattern or historic usage behavior and the expected usage weight will be less influenced by recently concluded sessions of the subscriber. A greater value of α will give less emphasis to the historic usage pattern or historic usage behavior and the expected usage weight will be more influenced by recently concluded sessions of the subscriber. The value of α may be configured by the network service provider based on their actual subscriber usage data; and business policies.

In another example, say for a data call, the consumption rate of service units would vary from subscriber to subscriber. The consumption rate may be dependent on various data consumption factors, like the data plan chosen by the user, network signal strength, mobility of the subscriber, interference, network traffic congestion, usage of subscriber at different time intervals, and so on. As mentioned earlier, the service units granted for data call is in terms of the volume of data to be transferred. For example, a network service provider may fix the predetermined number of service units for data calls. Each service unit may be equal to a predefined volume of data, say one hundred kilobytes (100 KB). It would be appreciated by those skilled in the art that, since most of the data consumption factors are dynamic and may change within very short time intervals, the consumption rate of a subsequent predetermined number of service units may vary from a preceding predetermined number of service units. Thus, the time interval after which the request for subsequent request for service units is generated would vary. To prevent wasting of bandwidth and overloading of the resource allocation system 102, the network service provider may aim to achieve a scenario in which the gap between requests for service units is a minimum pre-defined fixed time interval, say 100 seconds. In order to maintain the gap, the resource request module 112 may be allocated a predetermined, say X, number of service units. The predetermined number may be based on the consumption rate of the subscriber. For example, if the expected consumption rate of the subscriber is 15 KB per second, and the desired gap is 100 seconds, the resource request module 112 may be configured to allocate 15 service units each time.

In said example, say the resource request module 112 is configured to assign the new subscriber an expected slice of volume of data as the default. For all subsequent calls, the current expected consumption rate assigned to the new customer would be based on two usage parameters, namely, the previous actual consumption rate for the previous granted number of service units; and the previous expected consumption rate for the previous granted number of service units. The resource request module 112 may be configured to assign each of the usage parameters equal usage emphasis or either of the usage parameter may be assigned more emphasis than the other. For example, for the current request number is N, then the previous actual consumption rate for the previous request, i.e., the N−1^{th} request, for a subscriber is represented by ACR_{SUB(N-1)}, and the previous expected consumption rate is represented by ECR_{SUB(N-1)}. Thus, for the first request, ECR_{SUB(1)}, is determined by the network service provider. Then, as mentioned earlier, the current expected consumption rate of the subscriber, i.e., the N^{th} request is determined based on equation (2) which is reproduced below for the sake of readability.

ECR_{SUB(N)}=α×ACR_{SUB(N-1)}+(1−α)×ECR_{SUB(N-1)} {0<α<1} Equation (2)

As defined in the equation 1, in equation 2, α represents the smoothing factor. A lower value of a will give more emphasis or influence to the historic usage behavior and the expected consumption rate will be less influenced by recent consumption rates of the subscriber. A greater value of α gives less emphasis or influence to the historic usage behavior and the expected consumption rate will be more influenced by recent consumption rates of the subscriber. The value of a may be configured by the network service provider based on their actual subscriber usage data; and business policies. Based on the current expected consumption rate of the subscriber for the current request, ECR_{SUB(N)}, the resource request module 112 would determine the number of service units to request for the current request.

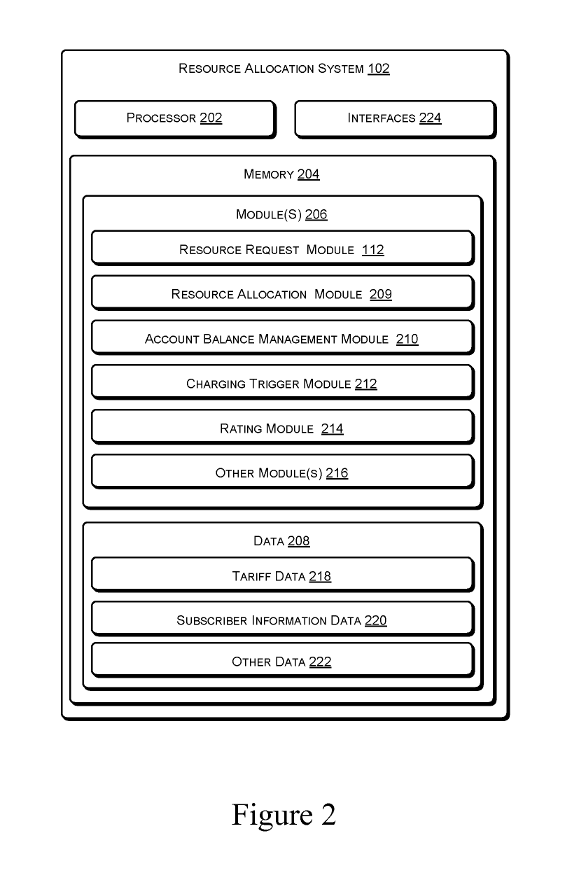

The resource allocation system 102 as described above optimizes the number of requests generated for granting of service units. These and other features of the resource allocation system 102 are described in greater detail, in conjunction with FIG. 2.

FIG. 2 illustrates the components of the exemplary resource allocation system 102, in accordance to an embodiment of the present subject matter. The resource allocation system 102 may be implemented as various computing devices, such as a computer, a server, a network server, a mainframe computer, and the like. In said embodiment, the resource allocation system 102 includes one or more processor(s) 202, henceforth referred to as processor 202, and a memory 204 connected to the processor 202. The processor 202 may include microprocessors, microcomputers, microcontrollers, digital signal processors, central processing units, state machines, logic circuitries and/or any other devices that manipulate signals and data based on operational instructions. The processor 202 can be a single processing unit or a number of units, all of which could also include multiple computing units. Among other capabilities, the processor 202 is configured to fetch and execute computer-readable instructions stored in the memory 204.

Functions of the various elements shown in the figures, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

The memory 204 can include any computer-readable medium known in the art including, for example, volatile memory, such as RAM and/or non-volatile memory, such as flash. The memory 204 further includes module(s) 206 and data 208. The module(s) 206 include routines, programs, objects, components, data structures, etc., which perform particular tasks or implement particular abstract data types. In one implementation, the module(s) 206 may include the resource request module 112. The module(s) 206 further include a resource allocation module 209, an account balance management (ABM) module 210, a charging trigger module 212, a rating module 214, and other module(s) 216. The other module(s) 216 may include programs or coded instructions that supplement applications and functions of the resource allocation system 102.

On the other hand, the data 208, amongst other things, serves as a repository for storing data processed, received, associated, and generated by one or more of the module(s) 206.

The data 208 includes, for example, tariff data 218, and subscriber information data 220. The data 208 may also include other data 222. The other data 222 includes data generated as a result of the execution of one or more modules in the other module(s) 216.

Further the resource allocation system 102 includes one or more interface(s) 224. The interfaces 224 may include a variety of software and hardware interfaces, for example, interfaces for peripheral device(s), such as data input output devices, referred to as I/O devices, storage devices, network devices, etc. The I/O device(s) may include Universal Serial Bus (USB) ports, Ethernet ports, host bus adaptors, etc., and their corresponding device drivers. The interface(s) 224 facilitate the communication of the resource allocation system 102 with various communication and computing devices and various communication networks, such as Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), IP-based network, Public Switched Telephone Network (PSTN), Integrated Services Digital Network (ISDN), networks that use a variety of protocols, for example, Hypertext Transfer Protocol (HTTP), Transmission Control Protocol/Internet Protocol (TCP/IP), Wireless Application Protocol (WAP).

The functioning of the resource allocation system 102 is described in detail in the context of voice calls, where the consumption rate of service units is fixed; and data calls, where the consumption rate of the service units is variable. In one implementation, the resource request module 112 initially requests for and is granted a pre-determined unit, say X, service units of network resource to a subscriber; wherein all the subscribers have a fixed consumption rate, such as in a voice call. In said implementation, the network service provider may categorize the subscribers into multiple subscriber groups based on the average duration of a voice call made by each of the subscribers. As mentioned earlier, for example, the subscribers whose average duration of voice calls is less than two minutes may be termed as very light data consumption rate subscribers; the subscribers whose average duration of voice calls is more than thirty minutes may be termed as very heavy data consumption rate subscribers and so on. Table-1, reproduced below for the ease of readability, provides an exemplary classification of the subscribers into five subscriber groups based on the average duration of a voice call made by each of the subscribers. However, in other implementations, the network service provider may group the subscribers into any number of subscriber groups based on actual operational data of the network service provider. Further, the network service provider may also modify the criterion for classification of the subscribers into the subscriber groups.

TABLE 1

| Group | Very Light | Light | Medium | Heavy | Very Heavy |
|---|---|---|---|---|---|
| Average | Less than 2 | 2-10 | 10-20 | 20-30 | Greater than 30 |
| Duration | minutes | minutes | minutes | minutes | minutes |
| Usage | 1 | 2 | 3 | 4 | 5 |
| weights | | | | | |
| (W) | | | | | |
| Granted | X | 2X | 3X | 4X | 5X |
| Service | | | | | |
| Units | | | | | |
| (W × X) | | | | | |

In the Table-1 depicted above, the resource request module 112 may be configured to associate each of the groups with a usage weight. The resource request module 112 may be configured to enhance the usage weight with the increase in average duration of a voice call. A person skilled in the art may configure the resource request module 112 to implement various mathematical formula and algorithms to compute the usage weights based on the average duration of a voice call. For the purpose of explanation of the present subject matter, the five subscriber groups have been assigned discrete usage weights 1, 2, 3, 4, and 5. In the present subject matter, on consumption of the predefined number of service units, the resource allocation module 209 may be configured to grant the usage weight number of times the predefined number of service units for allocation. The resource allocation module 209 may be configured to grant the subscriber the requested number of service units, provided the subscriber has the requisite credit for the same. For example, if the subscriber is of the subscriber group medium data consumption rate subscribers, the subscriber would be assigned 3X service units. In said implementation, the ABM module 210 may be configured to ascertain that the subscriber has the requisite balance for the allocation of the usage weight number of times the predefined number of service units. The ABM module 210 may be also configured to manage the account of the subscriber, credit recharges, deduct charges for network resource usage, maintain validity of the subscriber's account and so on.

In one implementation, the resource request module 112 may be configured to assign a usage weight to a new subscriber for the first voice call, by default. In one example, say the resource request module 112 may be configured to assign the new subscriber the usage weight 1 or any other fixed value. For all subsequent calls, the resource request module 112 may compute the usage weight to be assigned to the new customer would be based on two usage parameters, namely, the previous actual usage weight for the previous session, determined based on the duration of the previous session; and the previous expected usage weight for the previous session. The resource request module 112 may be configured to assign each of the usage parameters equal emphasis or either of the usage parameter may be assigned more emphasis than the other. As mentioned earlier, say the current session is N, then the previous actual usage weight for the previous session, i.e. the N−1^{th} session, for a subscriber is AW_{SUB(N-1)}, and the previous expected usage weight for the previous session is EW_{SUB(N-1)}. Thus, for the first session EW_{SUB(1)} may be any fixed value, say 1. Then the current expected usage weight of the subscriber for the current session, i.e., the N^{th} session is determined based on equation (1) given below.

EW_{SUB(N)}=α×AW_{SUB(N-1)}+(1−α)×EW_{SUB(N-1)} {0<α<1} Equation (1)

In one embodiment, say the value of a, as fixed by the network service provider is 0.6, and the predefined number of service units for allocation, represented by M, is fixed as 60 by the service provider. Say, for said subscriber, the first call lasts for 1200 seconds. Then the number of requests generated would be the duration of the call divided by the predefined number of service units for allocation, which is 20. However, the previous actual usage weight of the new subscriber as per Table-1 is 3. Thus, for the second session, the current expected usage weight of the subscriber calculated based on equation 1, and rounded off to the nearest integer is given below:

EW_{SUB(2)}=0.6×3+(1−0.6)×1=2 Equation (3)

Hence, for the second call, the current expected usage weight associated with the subscriber will be 2, and hence the resource allocation module 209 would now allocate the usage weight number of times the predefined number of service units, i.e., 120 service units, per request, provided the ABM module 210 determines that the subscriber has the requisite account balance for the same.

In said example, say the subscriber makes ten calls, each of varying duration.

Table-2 below shows the value of the usage weight of the subscriber for each of the calls. The expected usage weight for a call is computed before the allocation of network resource, in terms of service units, for the said call.

TABLE 2

| | Call | | |
|---|---|---|---|
| Session | Duration | Actual Usage | Expected Usage weight |
| No | in seconds | weight | (Rounded off to nearest integer) |
| 1 | 1200 | 3 | 1 |
| | | | (fixed value of service provider) |
| 2 | 1500 | 4 | 0.6 × 3 + (1 − 0.6) × 1 = 2 |
| 3 | 1800 | 4 | 0.6 × 4 + (1 − 0.6) × 2 = 3 |
| 4 | 1320 | 4 | 0.6 × 4 + (1 − 0.6) × 3 = 4 |
| 5 | 1200 | 3 | 0.6 × 4 + (1 − 0.6) × 4 = 4 |
| 6 | 600 | 2 | 0.6 × 3 + (1 − 0.6) × 4 = 3 |
| 7 | 1800 | 4 | 0.6 × 2 + (1 − 0.6) × 3 = 2 |
| 8 | 1500 | 4 | 0.6 × 4 + (1 − 0.6) × 2 = 3 |
| 9 | 2100 | 5 | 0.6 × 4 + (1 − 0.6) × 3 = 4 |
| 10 | 2400 | 5 | 0.6 × 5 + (1 − 0.6) × 4 = 5 |

As mentioned earlier, in the said implementation, the resource request module 112 is configured to assign the current expected usage weight number of times the predefined number of service units per request. Thus for the ten calls depicted in Table-2, Table-3 depicts the actual number of service units allocated per request, in accordance with an embodiment of the present subject matter.

TABLE 3

| | | Current Expected Usage | Actual number |
|---|---|---|---|
| | | weight | of service |
| | Call Duration | (Rounded off to nearest | units allocated |
| Session No | in seconds | integer) | per request |
| 1 | 1200 | 1 | 60 |
| | | (fixed value of service | |
| | | provider) | |
| 2 | 1500 | 2 | 60 × 2 = 120 |
| 3 | 1800 | 3 | 60 × 3 = 180 |
| 4 | 1320 | 4 | 60 × 4 = 240 |
| 5 | 1200 | 4 | 60 × 4 = 240 |
| 6 | 600 | 3 | 60 × 3 = 180 |
| 7 | 1800 | 2 | 60 × 2 = 120 |
| 8 | 1500 | 3 | 60 × 3 = 180 |
| 9 | 2100 | 4 | 60 × 4 = 240 |
| 10 | 2400 | 5 | 60 × 5 = 300 |

As is seen from Table-3, the number of service units per request increases which means a reduction in the number of request messages generated for allocation of network resource, as the number of request messages is related to the actual number of service units allocated per request as depicted in equation (4) below.

$$Number of request messages generated = \frac{Call Duration in seconds}{\begin{matrix}Actual number of service units \\ allocated per request\end{matrix}} \qquad Equation ( 4 )$$

Table-4 below shows a comparison of the number of request message generated using the conventional approach and using the concepts described in the present subject matter.

TABLE 4

| | | | | Number of | Number of | |
|---|---|---|---|---|---|---|
| | | | | request | request | Reduc- |
| | | | Current | messages | messages | tion |
| | Call | Current | Ex- | as per the | as per | in num- |
| Ses- | Duration | Actual | pected | present | conven- | ber of |
| sion | in | Usage | Usage | subject | tional | network |
| No | seconds | weight | weight | matter | techniques | request |
| 1 | 1200 | 3 | 1 | 20 | 20 | 0 |
| 2 | 1500 | 4 | 2 | 13 | 25 | 12 |
| 3 | 1800 | 4 | 3 | 10 | 30 | 20 |
| 4 | 1320 | 4 | 4 | 6 | 22 | 16 |
| 5 | 1200 | 3 | 4 | 5 | 20 | 15 |
| 6 | 600 | 2 | 3 | 3 | 10 | 7 |
| 7 | 1800 | 4 | 2 | 15 | 30 | 15 |
| 8 | 1500 | 4 | 3 | 8 | 25 | 17 |
| 9 | 2100 | 5 | 4 | 9 | 35 | 26 |
| 10 | 2400 | 5 | 5 | 8 | 40 | 32 |

Thus, it is seen from Table-4, that the present subject matter reduces the number of request messages by a great extent, and thus optimizes the usage of network resources and prevents congestion in the communication network. In said example, the resource request module 112 generates 97 requests in the ten calls as compared to the 257 requests generated in the ten calls following the conventional approach. Thus, there is a bandwidth saving of 62.2% as compared to the conventional approach. The bandwidth saving is computed based on the equation 5a provided below. In the equation 5a, N_{Conventional} represents the number of requests for allocation of network resources generated as per the conventional techniques; and N_{Present} represents the number of requests for allocation of network resources generated as per the present subject matter.

$$Bandwidth Saving = \frac{{N}_{Conventional} - {N}_{Present}}{{N}_{Conventional}} \times 100 \% \qquad Equation ( 5 a )$$

Thus, for the example described previously, the bandwidth saving is calculated as per equation 5b given below:

$$Bandwidth Saving = \frac{257 - 97}{257} \times 100 \% = \frac{160}{257} \times 100 \% = 62.2 \% \qquad Equation ( 5 b )$$

In another example, say for a data call, the consumption rate of service units would vary from subscriber to subscriber, and also, the consumption rate of service units of a single subscriber may vary with time. The consumption rate may be dependent on various data consumption factors, like the data plan chosen by the user, communication network signal strength, mobility of the subscriber, interference, communication network traffic congestion, usage of subscriber at different time intervals, and so on. As mentioned earlier, the resource allocation module 209 grants the service units for data call in terms of the volume of data to be transferred. For example, a network service provider may fix the predetermined number of service units for data calls. In one example, each service unit granted by the resource allocation module 209 may be equal to a predefined volume of data, say one hundred kilobytes (100 KB). Conventionally, on the subscriber consuming the predetermined number of service units, the resource allocation module 209 would grant another predetermined number of service units for the consumption of the subscriber, provided that the subscriber has credits for the same. In one implementation, the subscriber information data 220 may include various parameters such as the subscriber's personal details which may include name, address, proof of identity, residential address, billing address, and so on. In said implementation, the tariff data 218 may include tariff details such as voice call rates, data call rates, special packages availed by the subscriber, and so on. Based on the information retrieved from the tariff data 218, and the subscriber information data 220, the subscriber may be charged for the consumption of the service units. It is known by those skilled in the art that, since most of the data consumption factors are dynamic and may change within very short time intervals, the consumption rate of a subsequent predetermined number of service units may vary from a preceding predetermined number of service units. Thus, the time interval after which the resource request module 112 would receive requests for subsequent request for service units would vary. To prevent wasting of bandwidth and overloading of the resource allocation system 102, the network service provider may aim to optimize the number of requests for service units. For example, the network service provider may want to implement a minimum pre-defined fixed time interval, say 100 seconds, as the time duration between two consecutive requests for allocation of network resources. In order to maintain the minimum pre-defined fixed time interval between the requests, the resource request module 112 may generate requests for predetermined, say X, number of service units. The predetermined number may be based on the consumption rate of the subscriber. For example, if the expected consumption rate of the subscriber is 15 KB per second, and the desired gap is 100 seconds, the CTM may compute, request for and be granted 15 service units, i.e. 1500 kilobytes, each time.

In one example, say the resource request module 112 may be configured to assign the new subscriber an expected slice of volume of data as the default. For all subsequent session requests, the resource request module 112 computes the expected consumption rate assigned to the new subscriber, based on two usage parameters, namely, the previous actual consumption rate for the previous granted number of service units; and the previous expected consumption rate for the previous granted number of service units. The resource request module 112 may be configured to assign each of the usage parameters equal emphasis or either of the usage parameter may be assigned more emphasis than the other. For example, say the current request number is N, then the actual consumption rate for the previous request, i.e., the N−1^{th} request, for a subscriber is ACR_{SUB(N-1)}, and the expected consumption rate for the previous request is ECR_{SUB(N-1)}. Thus for the first request, ECR_{SUB(1)} is determined by the network service provider. As mentioned earlier, the expected consumption rate of the subscriber for the current request, i.e., the N^{th} request is determined based on equation (2) which is reproduced below for the sake of readability.

ECR_{SUB(N)}=α×ACR_{SUB(N-1)}+(1−α)×ECR_{SUB(N-1)} Equation (2)

{0<α<1}

Based on the expected consumption rate of the subscriber for the current request, ECR_{SUB(N)}, the resource request module 112 would determine the number of service units to request for the current request.

In one embodiment, say the value of a, as fixed by the network service provider is 0.6, and the predefined time interval, represented by t, is fixed as any fixed value, say 100 seconds, by the service provider. As mentioned earlier, the predefined time interval may be defined as the desired time duration between two consecutive requests for allocation of network resources. Further, say the consumption rate of the subscriber for the first set of granted number of service units is assumed by the resource request module 112 as any fixed value, say 15 kilobytes per second. Thus the resource allocation module 209 would first allocate 1500 kilobytes for the new subscriber.

Now the actual consumption rate of the subscriber for the current session may vary from the current expected consumption rate assumed by the resource request module 112.

Say, the actual consumption rate of the subscriber is 10 kilobytes per second. Then in accordance with the equation (2), the expected consumption rate for the next set of granted service units will be as depicted in equation (6) below and rounded off to the nearest integer.

ECR_{SUB(2)}=0.6×10+(1−0.6)×15)=12 kilobytes per second Equation (6)

Thus, the volume of slice of data granted as the second set of service units is 1200 kilobytes, i.e., 12 kilobytes per second×100 seconds. As mentioned earlier, the consumption rate of the subscriber is a dynamic factor and say is 15 kilobytes per second for the second set of service units. In said example, say the subscriber makes ten requests for network resources, wherein the data consumption rate of the subscriber may vary. Table-5 below shows the current actual consumption rate, and the current expected consumption rate as computed by the resource request module 112.

TABLE 5

| | Current Actual | Current Expected |
|---|---|---|
| | Consumption rate in the | consumption rate for |
| Set Number | present set number | present set number |
| 0 | 10 | 15 (assumed value) |
| 1 | 15 | 0.6 × 10 + (1 − 0.6) × 15) = 12 |
| 2 | 21 | 0.6 × 15 + (1 − 0.6) × 12) = 14 |
| 3 | 25 | 0.6 × 21 + (1 − 0.6) × 14) = 18 |
| 4 | 24 | 0.6 × 25 + (1 − 0.6) × 18) = 22 |
| 5 | 21 | 0.6 × 24 + (1 − 0.6) × 22) = 23 |
| 6 | 15 | 0.6 × 21 + (1 − 0.6) × 23) = 22 |
| 7 | 17 | 0.6 × 15 + (1 − 0.6) × 22) = 18 |
| 8 | 14 | 0.6 × 17 + (1 − 0.6) × 18) = 17 |
| 9 | 16 | 0.6 × 14 + (1 − 0.6) × 17) = 15 |
| 10 | 19 | 0.6 × 16 + (1 − 0.6) × 15) = 16 |
| 11 | 25 | 0.6 × 19 + (1 − 0.6) × 16) = 18 |
| 12 | 24 | 0.6 × 25 + (1 − 0.6) × 18) = 22 |
| 13 | 23 | 0.6 × 24 + (1 − 0.6) × 22) = 23 |
| 14 | 15 | 0.6 × 23 + (1 − 0.6) × 23) = 23 |
| 15 | 16 | 0.6 × 15 + (1 − 0.6) × 23) = 18 |
| 16 | 19 | 0.6 × 16 + (1 − 0.6) × 18) = 17 |
| 17 | 25 | 0.6 × 19 + (1 − 0.6) × 17) = 18 |
| 18 | 24 | 0.6 × 25 + (1 − 0.6) × 18) = 22 |
| 19 | 23 | 0.6 × 24 + (1 − 0.6) × 22) = 23 |
| 20 | 15 | 0.6 × 23 + (1 − 0.6) × 23) = 23 |

As mentioned earlier, the slice of volume of data provided as a set of service units provided is dependent on the current expected consumption rate of the subscriber as well as the predefined time interval, which is the minimum desired time duration between two consecutive requests for allocation of network resources, as fixed by the network service provider. Equation (7) below provides an exemplary relation of the slice of volume provided as a set of service units provided with the current expected consumption rate of the subscriber and the predefined time interval.

Slice of volume=Current Expected consumption rate×The predefined time interval Equation (7)

Table-6 below compares the time interval between two subsequent requests for allocation of service units based on the present subject matter and conventional techniques.

TABLE 6

| | Current | Current | Volume Slice | Time interval | Time interval |
|---|---|---|---|---|---|
| | Actual | Expected | of Service | before which a | before which a |
| | Consumption | consumption | Units | request is | request is |
| | rate in the | rate for | allocated as | generated as | generated as per |
| Set | present set | present set | per present | per present | conventional |
| Number | number | number | subject matter | subject matter | techniques |
| 0 | 10 | 15 | 1500 | 0 | 0 |
| 1 | 15 | 12 | 1200 | 150.00 | 100.00 |
| 2 | 21 | 14 | 1400 | 80.00 | 66.67 |
| 3 | 25 | 18 | 1800 | 66.67 | 47.62 |
| 4 | 24 | 22 | 2200 | 72.00 | 40.00 |
| 5 | 21 | 23 | 2300 | 91.67 | 41.67 |
| 6 | 15 | 22 | 2200 | 109.52 | 47.62 |
| 7 | 17 | 18 | 1800 | 146.67 | 66.67 |
| 8 | 14 | 17 | 1700 | 105.88 | 58.82 |
| 9 | 16 | 15 | 1500 | 121.43 | 71.43 |
| 10 | 19 | 16 | 1600 | 93.75 | 62.50 |
| 11 | 25 | 18 | 1800 | 84.21 | 52.63 |
| 12 | 24 | 22 | 2200 | 72.00 | 40.00 |
| 13 | 23 | 23 | 2300 | 91.67 | 41.67 |
| 14 | 15 | 23 | 2300 | 100.00 | 43.48 |
| 15 | 16 | 18 | 1800 | 153.33 | 66.67 |
| 16 | 19 | 17 | 1700 | 112.50 | 62.50 |
| 17 | 25 | 18 | 1800 | 89.47 | 52.63 |
| 18 | 24 | 22 | 2200 | 72.00 | 40.00 |
| 19 | 23 | 23 | 2300 | 91.67 | 41.67 |
| 20 | 15 | 23 | 2300 | 100.00 | 43.48 |

Table-7 below provides a comparative analysis of the payload delivered as per conventional techniques and payload delivered as per the techniques described in the present subject matter.

TABLE 7

| | Volume Slice of | Payload | | |
|---|---|---|---|---|
| | Service Units | delivered as | Volume Slice of | |
| | allocated as per | per | Service Units | Payload delivered |
| Set | conventional | conventional | allocated as per | as per present |
| Number | techniques | technique | present subject matter | subject matter |
| 0 | 1000 | 0 | 1500 | 0 |
| 1 | 1000 | 1000 | 1200 | 1500 |
| 2 | 1000 | 2000 | 1400 | 2700 |
| 3 | 1000 | 3000 | 1800 | 4100 |
| 4 | 1000 | 4000 | 2200 | 5900 |
| 5 | 1000 | 5000 | 2300 | 8100 |
| 6 | 1000 | 6000 | 2200 | 10400 |
| 7 | 1000 | 7000 | 1800 | 12600 |
| 8 | 1000 | 8000 | 1700 | 14400 |
| 9 | 1000 | 9000 | 1500 | 16100 |
| 10 | 1000 | 10000 | 1600 | 17600 |
| 11 | 1000 | 11000 | 1800 | 19200 |
| 12 | 1000 | 12000 | 2200 | 21000 |
| 13 | 1000 | 13000 | 2300 | 23200 |
| 14 | 1000 | 14000 | 2300 | 25500 |
| 15 | 1000 | 15000 | 1800 | 27800 |
| 16 | 1000 | 16000 | 1700 | 29600 |
| 17 | 1000 | 17000 | 1800 | 31300 |
| 18 | 1000 | 18000 | 2200 | 33100 |
| 19 | 1000 | 19000 | 2300 | 35300 |
| 20 | 1000 | 20000 | 2300 | 37600 |

Hence, it is seen for delivering a sample payload of a fixed size, say twenty thousand kilobytes, the resource allocation system 102 generates twelve requests as compared to the twenty requests generated using conventional techniques.

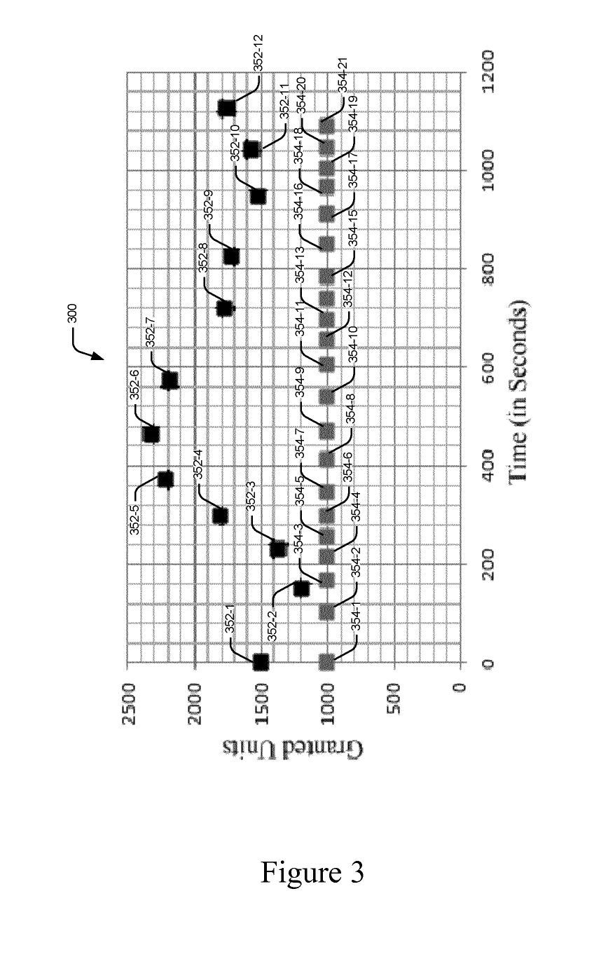

FIG. 3 illustrates a graph 300 depicting the number of messages exchanges for grant of service units with respect to time, in accordance with an embodiment of the present subject matter. The vertical axis of the graph 300 represents the volume of data granted in each request, whereas the horizontal axis of the graph 300 represents the time intervals at which the request was made. The squares 352-1, 352-2, . . . 352-12, represent the volume of data allocated to the subscriber based on the first, second, . . . twelveth request in accordance with the techniques described in the present subject matter. The squares 354-1, 354-2, . . . 354-21, represent the fixed volume of data, i.e., 1000 kilobytes, allocated to the subscriber based on the first, second, . . . twenty first request in accordance with the conventionally known techniques.

Thus, the resource allocation system 102 optimizes the number of requests generated by for granting of service units. For heavy data consumption rate subscribers, the resource allocation system 102 reduces the number of requests, thus preventing overloading of the resource allocation system 102 and preventing wastage of network bandwidth. For light data consumption rate subscribers, the resource allocation system 102 prevents unnecessary locking of service units from the subscriber's credit and thus facilitates the subscriber to initiate and use other concurrent session(s). Thus the resource allocation system 102 results in a bandwidth improvisation of 40% as compared to conventionally known techniques.

The bandwidth improvisation is computed based on the equation 8a provided below. In the equation (8a), NR_{Conventional} represents the number of requests for allocation of network resources generated for a payload of 20000 kilobytes as per the conventional techniques; and NR_{Present} represents the number of requests for allocation of network resources generated for a payload of 20000 kilobytes as per the present subject matter.

$$Bandwidth Improvisation = \frac{{NR}_{Conventional} - {NR}_{Present}}{{NR}_{Conventional}} \times 100 \% \qquad Equation ( 8 a )$$

Thus, for the example described previously, the bandwidth saving is calculated as per equation (8b) given below:

$$Bandwidth Improvisation = \frac{20 - 12}{20} \times 100 \% = \frac{8}{20} \times 100 \% = 40 \% \qquad Equation ( 8 b )$$

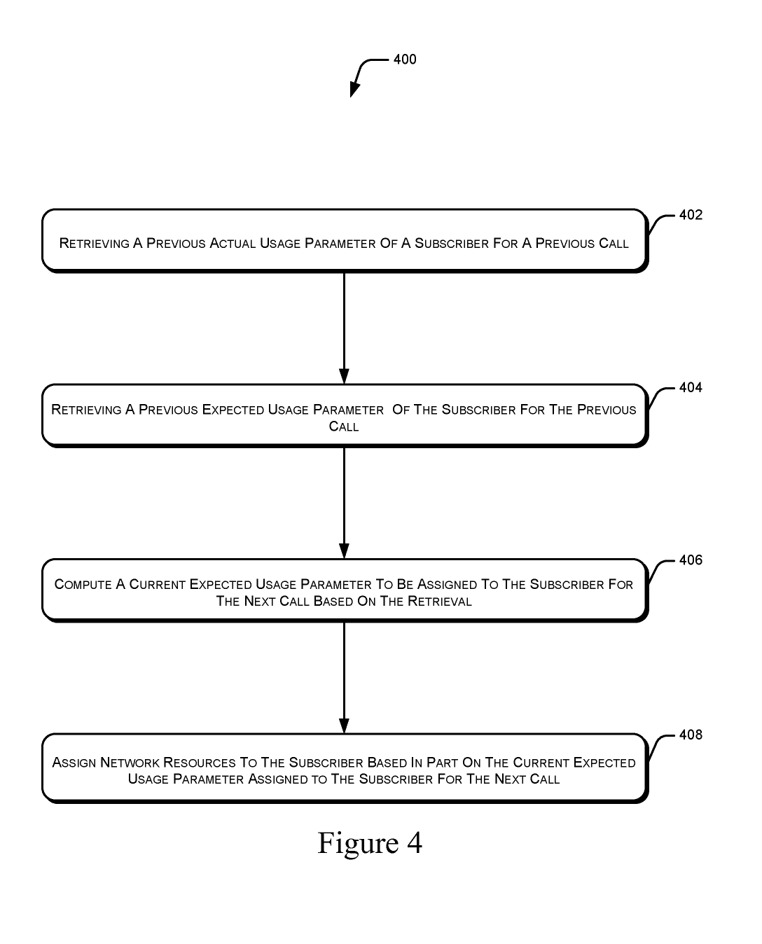

FIG. 4 illustrates exemplary method 400 for allocating service units of network resources, in accordance with an embodiment of the present subject matter. The order in which the method 400 is described is not intended to be construed as a limitation, and any number of the described method blocks can be combined in any order to implement the method 400, or an alternative method. Additionally, individual blocks may be deleted from the method 400 without departing from the spirit and scope of the subject matter described herein. Furthermore, the method 400 may be implemented in any suitable hardware, software, firmware, or combination thereof

A person skilled in the art will readily recognize that steps of the method 400 can be performed by programmed computers. Herein, some embodiments are also intended to cover program storage devices, for example, digital data storage media, which are machine or computer readable and encode machine-executable or computer-executable programs of instructions, where said instructions perform some or all of the steps of the described method 400. The program storage devices may be, for example, digital memories, magnetic storage media such as a magnetic disks and magnetic tapes, hard drives, or optically readable digital data storage media. The embodiments are also intended to cover both communication network and communication devices configured to perform said steps of the exemplary method 400. Further, the method 400 may be implemented in the resource allocation system 102 or may be implemented by various network entities.

With reference to method 400 as depicted in FIG. 4, as illustrated in block 402, a previous actual usage parameter for a previous session or a previous call is retrieved. For example, in case of a data call, wherein the consumption rate may be variable, the previous actual consumption rate of the service units of network resources is retrieved. Similarly, for a voice call, wherein the consumption rate of network resources is fixed, the previous actual usage weight assigned to the subscriber may be retrieved. In one implementation, the resource request module 112 may be configured to retrieve at least one of the previous actual consumption rate, and the previous actual usage weight of a subscriber from the subscriber information data 220.

As depicted in block 404, a previous expected usage parameter of a subscriber for the previous session or the previous call is retrieved. For example, in case of a data call, the previous expected consumption rate of the service units of network resources is retrieved, whereas for a voice call, the previous expected usage weight assigned to the subscriber may be retrieved. In one implementation, the resource request module 112 may be configured to retrieve at least one of the previous expected consumption rate and the previous expected usage weight of a subscriber from the subscriber information data 220.

As shown in block 406, a current expected usage parameter of a subscriber for the next session or the next call is computed. In one example, the resource request module 112 may be configured to compute the current expected usage weight of the subscriber for the next session based on the previous actual usage weight for the previous call, determined based on the duration of the previous call; and the previous expected usage weight for the previous call, in accordance with equation (1) mentioned below:

EW_{SUB(N)}=α×AW_{SUB(N-1)}+(1−α)×EW_{SUB(N-1)} Equation (1)

{0<α<1}

In another example, the resource request module 112 may be configured to compute the current expected consumption rate of the subscriber for the next session based on the previous actual consumption rate for the previous session. The current expected consumption rate of the subscriber may be determined based on the duration of the previous session; and the previous expected consumption rate for the previous session, in accordance with equation (2) mentioned below:

ECR_{SUB(N)}=α×ACR_{SUB(N-1)}+(1−α)×ECR_{SUB(N-1)} Equation (2)

{0<α<1}

As described in block 408, the network resources measured in terms of service units is assigned to a subscriber based the current expected usage parameter computed for the subscriber. In one implementation, the resource allocation module 209 is configured to allocate the expected usage weight number of times the predefined number of service units.

Thus, the method 400 for allocating service units of network resources, as described above optimizes the number of requests generated for granting of service units. For heavy data consumption rate subscribers, the resource allocation system 102 reduces the number of requests, thus preventing overloading and preventing wastage of network bandwidth. For light data consumption rate subscribers, the resource allocation system 102 prevents unnecessary locking of service units from the subscriber's credit and thus facilitates the subscriber to initiate and use other concurrent session(s).

Although implementations for allocation of network resources in communication networks have been described in language specific to structural features and/or methods, it is to be understood that the appended claims are not necessarily limited to the specific features or methods described. Rather, the specific features and methods are disclosed as exemplary implementations for allocation of network resources in communication networks.

1. A method for allocating network resources for a current call to a subscriber of a communication network, the method comprising:
determining a previous actual usage parameter associated with the subscriber, wherein the previous actual usage parameter is indicative of previous allocation of the network resources made to the subscriber for at least one previous call;
retrieving a previous expected usage parameter associated with the subscriber, wherein the previous expected usage parameter is indicative of expected usage of the network resources made by the subscriber for the at least one previous call;
computing a current expected usage parameter associated with the subscriber for a current allocation of the network resources based on the previous actual usage parameter and the previous expected usage parameter; and
allocating the network resources to the subscriber based on the current usage parameter.

2. The method as claimed in claim 1, wherein at least one of the previous actual usage parameter, the previous expected usage parameter, the current expected usage parameter is measured in terms of consumption rate of service units of the network resources for a call having variable consumption rate of network resources.

3. The method as claimed in claim 2, wherein the network resources are measured in terms of volume of data, and wherein the call having variable consumption rate of the network resources is a data call.

4. The method as claimed in claim 1, wherein at least one of the previous actual usage parameter, the previous expected usage parameter, the current expected usage parameter is measured in terms of a usage weight associated with the subscriber for a call having fixed consumption rate of the network resources.

5. The method as claimed in claim 4, wherein the network resources are measured in terms of duration of usage of the network resources, and wherein the call having fixed consumption rate of the network resources is a voice call.

6. The method as claimed in claim 1, wherein the computing is based on a smoothing factor, wherein the smoothing factor determines an influence of historic usage behavior of the subscriber on the current usage parameter.

7. The method as claimed in claim 1, wherein the method further comprises determining whether the subscriber has requisite credit for being allocated the network resources for the current call.

8. The method as claimed in claim 1, wherein the retrieving further comprises analyzing historic usage behavior of the subscriber to determine an average call duration of the subscriber such that the previous expected usage parameter is based on the average call duration.

9. The method as claimed in claim 8, wherein the retrieving further comprises classifying the subscriber into at least one subscriber group based on the average call duration of the subscriber.

10. A resource allocation system comprising:
a processor; and
a resource request module, coupled to the processor, and configured to:
determine a previous actual usage parameter associated with the subscriber for a previous allocation of network resources;
retrieve a previous expected usage parameter associated with the subscriber for the previous allocation of network resources; and
compute a current expected usage parameter associated with the subscriber for a current allocation of network resources based on the determining and the retrieving.

11. The resource allocation system as claimed in claim 10 further comprising a resource allocation module coupled to the processor, and configured to allocate the network resources for a current session to the subscriber based on the current expected usage parameter.

12. The resource allocation system as claimed in claim 11 further comprising an account balance management module 210, coupled to the processor, and configured to:
manage account information of the subscriber; and
determine whether to allocate the network resources to the subscriber for the current session based on the account information of the subscriber and at least in part on the current expected usage parameter.

13. The resource allocation system as claimed in claim 11 wherein the resource request module is further configured to generate request for network resources based on the current usage parameter.

14. A non-transitory computer-readable medium having embodied thereon a computer program for executing a method comprising:
determining a previous actual usage parameter associated with the subscriber, wherein the previous actual usage parameter is indicative of previous allocation of the network resources made to the subscriber for at least one previous call;
retrieving a previous expected usage parameter associated with the subscriber, wherein the previous expected usage parameter is indicative of expected usage of the network resources made by the subscriber for the at least one previous call;
computing a current usage parameter associated with the subscriber for a current allocation of the network resources based on the previous actual usage parameter and the previous expected usage parameter; and
allocating network resources to the subscriber based on the current usage parameter.

15. The non-transitory computer-readable medium as claimed in claim 14, wherein the usage parameter is at least one of a consumption rate of service units of network resources for a call having variable consumption rate of network resources and an usage weight associated with the subscriber for the call, having fixed consumption rate of network resources.
